(19) United States
(12) Patent Application Publication
(10) Pub. No.: US 2012/0137275 A1
(43) Pub. Date: May 31, 2012

(54) Tracking Information Flow

(75) Inventor: Ernest S. Cohen, Wyncote, PA (US)

(73) Assignee: Microsoft Corporation, Redmond, WA (US)

(21) Appl. No.: 12/954,904

(22) Filed: Nov. 28, 2010

(51) Int. Cl. G06F 9/44

(52) U.S. Cl. 717/131

(57) ABSTRACT

This invention provides a technique for tracking information flow in a computer program or system, dynamically marking variables as high or low to indicate whether there has possibly been direct flow to that variable from the data initially marked high. Each conditional and loop test is classified as high or low, based only on low data. An assignment of an expression to a variable marks the variable high if the expression contains a variable marked high, or if the assignment occurs during execution of the body of a test that was classified as high; otherwise the assignment marks the variable low. Program execution aborts if the classifying expression for a test depends on the value of a high variable, or if the test is classified low, the test includes a high variable, and the test evaluates to false.

### BACKGROUND

In the field of computer security it is often important to track information flow during execution of a computer program or system. Tracking information flow means detecting whether the value of a particular variable at one point in a program execution can possibly convey information about the value some other variable might have held at an earlier point in the execution.

For simplicity of presentation, methods for tracking information flow are typically described by labeling each program variable at the beginning and end of an execution as either low security or high security. The goal of a tracking method is to guarantee that the final values of the variables labeled low at the end of the execution do not provide any information about the initial values of those variables that were labeled high at the beginning of the execution (i.e., no information should flow from high variables to low variables), a condition generally known as “noninterference.” Most existing methods for tracking information flow classify each program variable at each point of an execution (not just at the beginning and end of execution), indicating whether that variable possibly contains information about the initial values of the initially high variables.

Program execution can cause the flow of information from one variable to another in two ways, generally known as “explicit flow” and “implicit flow”. Explicit information flow occurs when the value of one variable is used to compute a value that is assigned to another variable. For example, execution of the program statement x:=y+z (which assigns to x the sum of y and z) might cause information to flow from y and/or z to x. Thus, to maintain the integrity of the of the variable classification, if either y or z was labeled high at the beginning of the assignment, then x must be labeled as high after the assignment.

The tracking of explicit flow entails an additional refinement in the presence of conditionals or loops. For example, consider the program if (h=0) x:=0; if (h=1) x :=1; . . . where h is initially labeled high; this program obviously has the same effect as x:=h, and so should leave x marked high, even though none of the assignments to x involve high variables. The usual solution is to treat any assignment as high if it occurs within the block of a conditional or loop that is guarded by a (conditional or loop) test in which one of the variables was high. Thus, in this example, whichever conditional actually assigns to x would mark x high, since the conditional test includes a high variable (h).

“Implicit flow” occurs when information flows into a variable because of an assignment that doesn't happen. For example, consider the program if (h=1) then x :=1 where x is initially 0. Even if h is not equal to 1, information about h flows into x, since an x value other than 1 indicates that h is not equal to 1.

Implicit flows might not seems serious; indeed, if the only implicit flows were into output variables that were used for no other purpose, implicit flow could leak at most one bit of information, regardless of the number of output variables (as long as program execution aborted whenever any of them received explicit high flow). However, implicit flow creates a problem because variables that have received implicit flow can be used as tests for conditionals or loops. For example, the program if (h) then x :=1; if (x==0) then y :=0 (where h is initially 0 or 1, x is initially 0 and y is initially 1) has the effect of copying h to y. Moreover, if we only track direct flow, then regardless of the initial value of h, y will not be labeled high. Repeating this for many different h bits allows an arbitrary amount of high information to be leaked to output without being detected by direct flow tracking. This shows that tracking only direct flow is insufficient.

The accepted solution to this problem is to put a further restriction on the tracking of flow, one that demands that at every control point, the labeling of variables as high or low should not depend on high data. For example, in the program above, in the first conditional assignment if (h) then x :=1, this restriction would require that x should be labeled high, regardless of the value of h. Similarly, since x must be labeled high after the first conditional assignment, the second assignment if (x==0) then y :=0 must similarly label y high, regardless of the value of x. Thus, the whole computation would leave x labeled high, tracking the previously untracked flow.

However, this solution has several serious drawbacks. First, it makes it difficult to track flow dynamically, because a variable might have to be labeled high because of code that was not even executed. Indeed, it is known that sound, fully dynamic tracking under this criterion is necessarily less sensitive than static type analysis of flow (where one chooses a level for each variable at each control point, and checks that these assignments of level cannot be broken by any program step).

Second, because it essentially treats implicit flow as equivalent to explicit flow, it results in many secure programs being classified as insecure. For example, the program if (h) then x :=1; if (h) then abort; return x, where x and h are initially labeled low and high, respectively, would be classified as insecure (because the first conditional assignment would have to label x high), even though the equivalent program if (h) then then abort; return x would be classified as secure.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a flow diagram showing examples of actions performed to verify or monitor information flow in an execution of a program.

FIG. 2 is flow diagram showing an example of assignment handling in conjunction with the actions of FIG. 1.

FIG. 3 is a block diagram of a system that can be used to implement the techniques described herein.

### SUMMARY

The information flow tracking techniques described herein avoid the difficulties described above. They provide the same degree of end-to-end information flow security as existing techniques, while classifying a strictly larger class of programs as secure. Unlike existing techniques, the techniques described herein allow the labeling of variables to depend on high data, and the label on a variable is changed only when the variable is actually assigned to. To deal with implicit flow, each loop and conditional test is classified as high or low (based only on low data). If a test is classified as high, the corresponding body is treated as if the test expression was high (i.e., any assignments during execution of the body mark the target of the assignment high). If a test is classified as low, then the system aborts execution if the test expression, at runtime, includes one or more high variables and the test fails. This restriction for low tests can be checked either dynamically during execution or statically via program analysis.

### DETAILED DESCRIPTION

For purposes of discussion, techniques will be described below in the context of a program that includes variables, assignments, conditionals, and loops. Conditional and loops include blocks of code. Conditionals and loops also include associated tests, referred to as conditional or loop tests, or simply as conditional tests. In the following discussion, the term “conditional” is used to describe both conditionals and loops.

The program executes in response to a data query, resulting in an “execution” of the program. Each execution may take a different execution path, determine by the conditional logic embedded within the program. Each execution may terminate by providing data output. This is considered the normal response to a request by a low or unprivileged client for low data. Alternatively, an execution of the program may abort. The term “abort” is intended to describe any non-terminating execution, in which data is not output or returned in response to the query. Entry into an infinite loop is considered a non-terminating response.

Variables are labeled as either high or low. This terminology captures the potential information content of a variable with respect to a single source of information. The method extends naturally to multiple sources of information.

In accordance with certain embodiments described herein, tests associated with conditionals are also classified as high or low. These classifications can be made prior to runtime, or may be made dynamically, during program execution.

During execution, a test is said to be labeled high in a state if it contains a variable that is labeled high in that state. In the following discussion, the description “high at runtime” means that the test is labeled high when program control reaches the test in a particular runtime state. The label on a test is independent of its classification, so a test might be classified as high but labeled low in a particular runtime state, or classified as low and labeled high in a particular runtime state.

The context of an execution is said to be high during the execution of any conditional whose test either (a) has a high classification or (b) is labeled high at runtime. The context remains high if some nested conditional has a test that is classified as low. At other times, the execution context is said to be low.

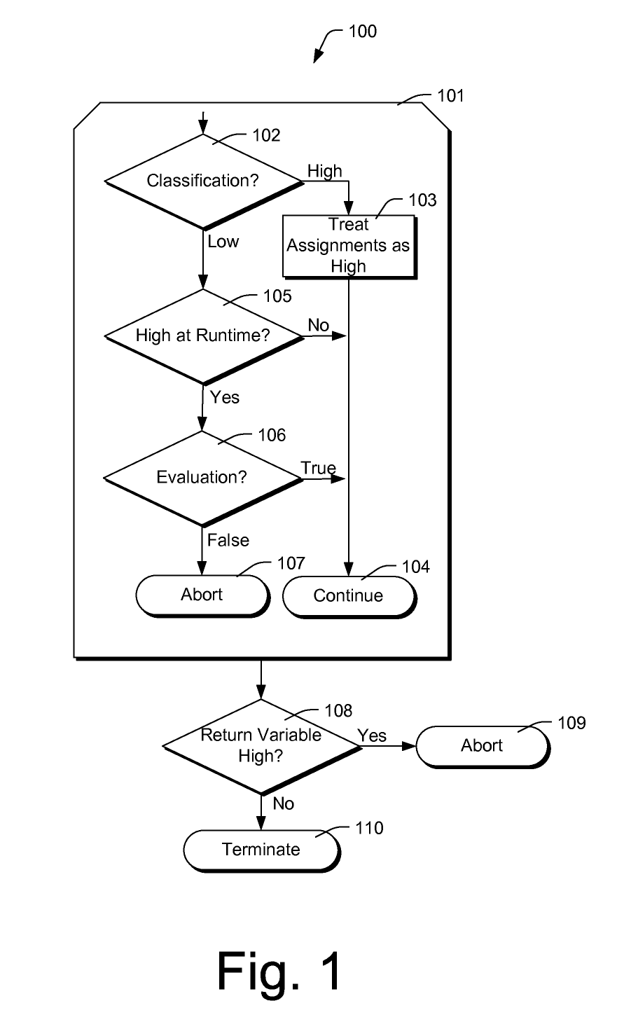

FIG. 1 illustrates an example method 100 of checking information flow during execution of a program. During the execution, assignments and other actions are performed in accordance with program statements and instructions. The actions within the illustrated block 101 are potentially performed when executing or encountering single statements or instructions. More specifically, the actions within block 101 are performed with respect to individual conditionals that are encountered during the program execution.

Note that prior to any execution, individual variables are labeled as being either high or low, and variable labels are updated during the execution to track whether the values of the variables potentially depend on the initially high data. Assignments are treated as follows: any variable that receives an assignment is labeled high if the expression being assigned contains any high variables or if the assignment takes place in a high context; otherwise, the variable's label is set to low.

At 102, conditional tests are classified as high or low. This classification may be made statically, by assignment prior to runtime. Alternatively, classifying 102 may be performed dynamically, during the program execution. For instance, the program may include classifying statements that determine whether individual conditionals are to be classified as high or low. In the described embodiments, the classifying statements may themselves comprise conditional tests. However, these conditional tests are does not depend on data that is high at runtime. In other words, conditional classifications are based only on low data.

If a particular conditional test, associated with a particular conditional, is classified as high, an action 103 is implemented, which comprises treating any assignments performed within the conditional as if they contain expressions that include high variables. This can accomplished by making the execution context high while within the conditional. Execution then continues as indicated by 104, and the process within block 101 is repeated for any further statements within the execution.

If the conditional test is classified as low, the execution performs 105, which comprises determining whether the conditional test is high at runtime: whether at runtime the conditional test has or relies on any high variables. If it does not, the execution simply continues as indicated by block 104. If the conditional test is not high at runtime, the execution evaluates the conditional test at 106, to determine whether its test expression is true or false. If the test expression evaluates as false, execution continues as indicated by 104. If the test expression evaluates as true, the execution is aborted at 107.

Note that 105 and 106 can be performed in any order; in combination, the effect of 105 and 106 is that the execution aborts if the test expression evaluates as false and is labeled high at runtime.

The sequence described above results in the execution context being set to high within a given conditional whenever (a) the conditional's test is high at runtime or (b) the conditional's test is classified as high.

Unless aborted, the actions of block 101 repeats until ready to return output variables. Prior to returning output variables, the procedure performs a check 108 to determine whether of any of the output variables have been labeled high. If one or more output labels has been labeled high, the execution is aborted at 109. Otherwise, the execution terminates and returns the output variables at 110.

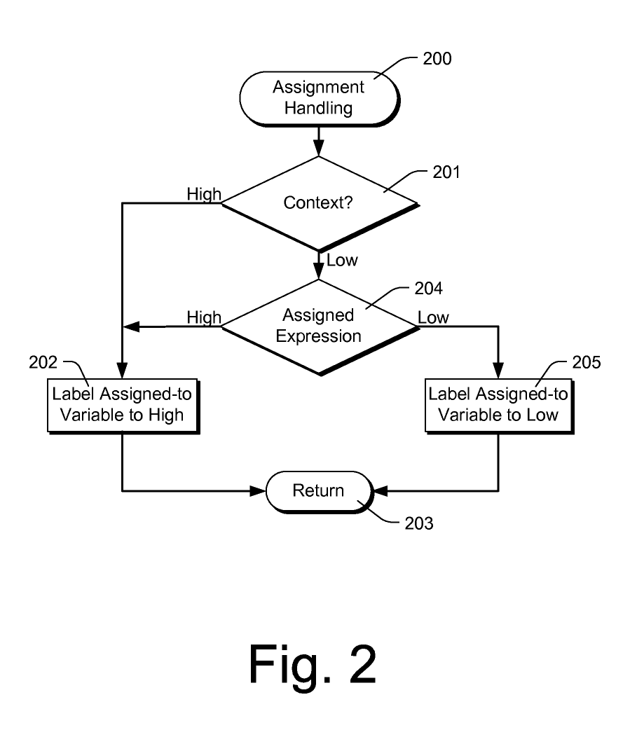

FIG. 2 illustrates an example 200 of how the execution context affects the handling of assignments. Generally, the security label of any variable that receives an assignment within a high execution context is updated to indicate a high security level. More specifically, an action 201 comprises determining whether the execution context is currently high or low. If it is high, an action 202 is performed, comprising labeling the assigned-to variable of the assignment as high. The procedure then returns at 203. If at 201 the execution context is low, an action 204 is performed, comprising evaluating the assigned expression to determine whether it is high or low. If it is high, action 202 is performed, labeling the assigned-to variable as high. The procedure then returns at 404. Otherwise, if the assigned expression is low, the procedure performs an action 205, setting the assigned-to variable to low. The procedure then returns at 203.

Thus, within any conditional or loop whose associated test is (a) classified as high or (b) labeled as high at runtime, all assignments are treated as high. During execution, the program is expected to either terminate or abort, based on an evaluation of one or more of the following conditions: (a) whether the tests of the program are classified as low or high, (b) whether the tests evaluate as true or false, or (c) whether or not the test is labeled high (i.e., includes high variables). More specifically, the execution is expected to abort if the following conditions are met for at least one conditional or loop that is executed during the execution: (a) the associated test is classified as low, (b) the associated test evaluates as false, and (c) the associated test includes a high variable. The program should also abort if the classifying expression itself contains a high variable.

To provide classical termination-insensitive noninterference, the program is also expected to abort if an attempt is made to provide as output any expression depending on a high variable. This test is not needed for other embodiments, where information flow is tracked for non-security purposes, such as in the implementation of program slicing.

The descriptions above assume that conditionals are of the form if (p) C. The techniques can be extended to if (p) then C1 else C2 in two ways. First, since this latter form is equivalent to if (p) C1; if (!p) C2 (assuming neither branch modifies the variables of p), the same classification can simply be used for both conditionals. This means that a conditional classified low but labeled high at runtime causes abortion, regardless of whether the test evaluates to true or false. In another embodiment, the classifiers for the two conditionals are given separately, potentially allowing more cases to be classified as low at the cost of potentially greater classification burden on the programmer.

In some embodiments, the system may maintain for each variable not just a label for the variable but a label for that label—referred to herein as the metalabel of the variable. The metalabel is allowed to be high only if the label is high, so this amounts to allowing three different labels for a variable: low, high (high label and low metalabel), and very high (high label and high metalabel). In one embodiment, these extended labels are handled as follows. Code within a low execution can, at any time, change the level of a variable to high through explicit annotation to that effect. An assignment to a variable in a low context labels the variable very high if some variable in the assigning expression is very high and no variable in the assigning expression is high; otherwise, it labels the variable high. An assignment to a variable in a high context labels the variable very high if the variable was not already labeled high.

The advantage of maintaining metalabels arises from the following optimization to the classification of conditionals. Suppose a conditional test is, at runtime, labeled high but not very high (that is, it has some variable that is labeled high but not very high, and no variable in the test is labeled very high). Such a label guarantees that the test can never be labeled low in any execution starting from a low-compatible state, so there is no danger of a conflict arising from “no-low-pass”. Thus, the execution need not be aborted, even if the test is classified as low and evaluates as false. This allows many tests to be safely classified as low, as long as their runtime levels are not very high.

The described techniques can be applied to programs with arrays as follows. Each element of an array is given a separate label, and treated as a separate variable. An assignment to an array element of the form a[e1]:=e2 labels a high at index e1 if e1 is high, if e2 is high, or if the assignment is done in a high context. In an expression, the term a[e1] is considered to be labeled high if e1 is high or if a is high at index e1. Again, only those array elements actually assigned to have to have their labels changed. This is a great improvement to state-of-the-art approaches to tracking flow are forced to treat entire arrays as having a single label.

The above treatment of arrays is not sufficient when low and high code compete for indices in the array. For example, memory allocator can be viewed as giving out addresses within a single array representing memory. Because the allocator provides memory to both low code and high code, the addresses if memory given to low code will depend on the memory demands of high code, and so must be labeled high. However, while low code cannot safely do arbitrary computations on such pointers, it should be able to safely compare its own pointers for equality, since the results of such tests are not affected by the memory allocation behavior of the high code.

One class of embodiments that do handle this situation is to maintain sets of pointers called “clubs”. A club is a collection of variables for which the equality test between any pair of variables is low (even though the variables themselves might be high). Given a club, a variable from outside the club can be assigned the value of any variable within the club, and in doing so, joins the club. Conversely, if a variable is assigned a value other than from a variable in the club, it leaves the club. Finally, a new variable can be added to the club by assigning to that variable a value unequal to those stored in variables in the club.

In this embodiment, for each index in an array, we associate (in addition to a label for that index) a set of clubs to which it belongs. In addition, for every variable we maintain a set of clubs to which it belongs. On an assignment x :=y, the club set of x is set to the club set of y. On an assignment a[x]:=e, the club set of index x in a is set to the club set of (the variable) x. The expression a[x] is considered to be labeled high if the variable a[x] is labeled high or if the intersection of the club set of the variable x and the club set of index x of a is empty; otherwise the expression a[x] is considered to be labeled low.

The present invention lends itself to two kinds of embodiments. In one kind of embodiment, labels on variables are maintained at runtime, using well-known techniques such as by additional code compiled into the program, runtime monitoring, or metaprogramming. In such an embodiment, before providing output from the program, some or all of the outputs are checked to make sure that their labels are low; if this test fails, execution aborts, or other measures are taken to prevent consequences from the potential release of secret information. In the other kind of embodiment, static analysis, program verification, or other tools are used to guarantee in advance that outputs would be labeled low at runtime if runtime monitoring were to be done, making the actual runtime monitoring unnecessary and thereby reducing the overhead of flow tracking. These two kinds of embodiments can also be combined into a single system, with static analysis used on some parts and monitoring used on other parts.

Note that while the techniques above are described with reference to a system with only two security levels, the invention works equally well in a setting with any number of partially ordered security levels. In one embodiment, the security levels are embedded into an atomic lattice; each atom can be viewed as representing a source of information. The system then maintains the label of a variable as a set of atoms, where an atom is in the set if and only if the label with respect to that atom is high. The techniques described herein can then be applied on an atom-by-atom basis, with the obvious optimizations of treating groups of atoms in a uniform manner.

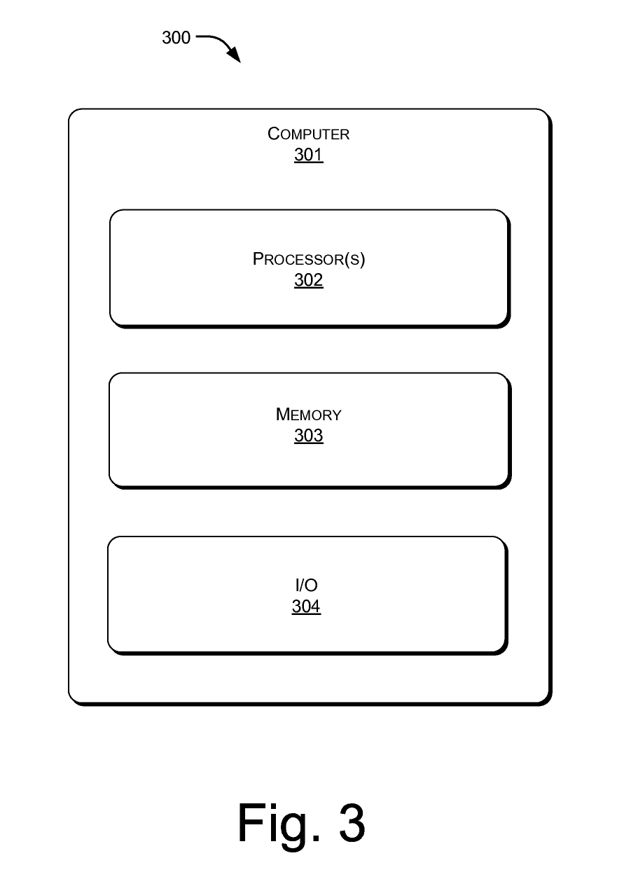

FIG. 3 shows relevant high-level components of system 300, as an example of various types of computing equipment that may be used to implement the techniques described above. In one implementation, system 300 may comprise a general-purpose computer 301 having one or more processors 302 and computer-readable memory 303. The test procedures described above can be implemented as software 304, such as one or more programs or test routines, comprising sets or sequences of instructions that reside in memory 303 for execution by the one or more processors 302. The computer 301 may have input/output facilities 304 for providing input or stimuli to a system being tested or monitored, and for observing system response. The input/output facilities may allow various different types of interaction with a system under test, such logical, visual, electrical, and/or physical interactions.

The program discussed above may reside in memory 303 and be executed by the processors 302, and may also be stored and distributed in various ways and using different means, such as by storage on different types of computer-readable memory 303, including portable and removable media.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims. For example, the methodological acts need not be performed in the order or combinations described herein, and may be performed in any combination of one or more acts.

1. A method for checking information flow within a program, wherein the program includes conditionals, loops, and associated tests; the method comprising:
classifying the tests associated with the conditionals and loops as high or low;
maintaining a label for each variable of the program indicating whether the variable is high or low;
during execution of any conditional or loop whose associated test is classified as high, treating assignments as high;
during execution of any conditional or loop whose associated test includes a high variable, treating assignments as high;
determining that the execution of the program should abort if the following conditions are met for at least one conditional or loop that is executed during execution of the program: (a) the associated test is classified as low, (b) the associated test evaluates as false, and (c) the associated test includes a high variable.

2. The method of claim 1, wherein the method is carried out by means of a static analysis of the program.

3. The method of claim 1, wherein the method is carried out during runtime execution of the program.

4. The method of claim 1, wherein the classifying is performed by statically designating each of the tests as high or low prior to the execution of the program.

5. The method of claim 1, wherein the classifying is performed by dynamically designating each of the tests as high or low during the execution.

6. The method of claim 1, wherein the classifying is performed by associating classifying expressions with the tests and by dynamically evaluating the classifying expressions during the execution of the program.

7. The method of claim 1, wherein the classifying is performed by associating classifying expressions with the tests and by dynamically evaluating the classifying expressions during the execution of the program, wherein the classifying expressions do not include high variables.

8. The method of claim 1, wherein the classifying is performed by associating classifying expressions with the tests and by dynamically evaluating the classifying expressions during the execution of the program, the method further comprising aborting the execution upon execution of a classifying expression that includes a high variable.

9. A method for checking information flow within a program, wherein the program includes conditionals, loops, and associated tests; the method comprising:
classifying the tests associated with the conditionals and loops as high or low;
during execution of any conditional or loop whose associated test is classified as high, treating assignments as high; and
determining whether an execution of the program execution should terminate based on one or more of the following conditions: (a) whether the tests are classified as low or high, (b) whether the tests evaluate as true or false; or (c) whether the tests includes high variables.

10. The method of claim 9, wherein the method is carried out by means of a static analysis of the program.

11. The method of claim 9, wherein the method is carried out during runtime execution of the program.

12. The method of claim 9, further comprising, during execution of any conditional or loop whose associated test includes a high variable, treating assignments as high.

13. The method of claim 9, wherein the determining comprises concluding that the execution of the program should abort if the following conditions are met for at least a single conditional or loop that is executed during execution of the program: (a) the associated test is classified as low, (b) the associated test evaluates as false, and (c) the associated test includes a high variable.

14. The method of claim 9, further comprising aborting the execution of the program if the following conditions are met for at least a single conditional or loop that is executed during execution of the program: (a) the associated test is classified as low, (b) the associated test evaluates as false, and (c) the associated test includes a high variable.

15. The method of claim 9, wherein the classifying is performed by statically designating each of the tests as high or low prior to the execution of the program.

16. The method of claim 9, wherein the classifying is performed by dynamically designating each of the tests as high or low during the execution.

17. The method of claim 9, wherein the classifying is performed by associating classifying expressions with the tests and by dynamically evaluating the classifying expressions during the execution of the program.

18. The method of claim 9, wherein the classifying is performed by associating classifying expressions with the tests and by dynamically evaluating the classifying expressions during the execution of the program, wherein the classifying expressions do not include any high variables.

19. The method of claim 9, further comprising maintaining for each variable (a) a label indicating whether the variable is high or low and (b) a metalabel indicating whether the label is high or low.

20. One or more computer-readable storage media containing instructions to check information flow within a program, wherein the program includes conditionals, loops, and associated tests, the tests being classified as high or low; the instructions being executable by a processor to perform actions comprising:
during execution of any conditional or loop whose associated test is classified as high, treating assignments as high; and
determining that the execution of the program should abort if the following conditions are met for at least a single conditional or loop that is executed during execution of the program: (a) the associated test is classified as low, (b) the associated test evaluates as false, and (c) the associated test includes a high variable.
